(19) United States
(12) Patent Application Publication
(10) Pub. No.: US 2026/0171660 A1
(43) Pub. Date: Jun. 18, 2026

(54) ANTENNA DEVICE

(71) Applicant: Lite-On Technology Corporation, Taipei (TW)

(72) Inventor: Yu-Ting Hsueh, Taipei (TW)

(73) Assignee: Lite-On Technology Corporation, Taipei (TW)

(21) Appl. No.: 19/033,508

(22) Filed: Jan. 22, 2025

(30) Foreign Application Priority Data
Dec. 16, 2024 (CN) 202411853455.8

(51) Int. Cl. H01Q 1/42

(52) U.S. Cl. CPC H01Q 1/42

(57) ABSTRACT

An antenna device including a circuit board, a wireless module, an antenna module, and a fixing cover is provided. The circuit board has a first connector. The wireless module is disposed on the circuit board and is electrically connected to the first connector through the circuit board. The antenna module includes an antenna, a transmission cable, and a second connector. The transmission cable is connected between the antenna and the second connector, and the second connector is connected to the first connector. The fixing cover is fixed to the circuit board, and the fixing cover is in contact with the second connector.

### CROSS-REFERENCE TO RELATED APPLICATION

This application claims the priority benefit of China application serial no. 202411853455.8, filed on Dec. 16, 2024. The entirety of the above-mentioned patent application is hereby incorporated by reference herein and made a part of this specification.

### BACKGROUND

### Technical Field

The disclosure relates to a device, and more particularly, to an antenna device.

### Description of Related Art

In the conventional technology, an antenna module is electrically connected to a main circuit board through a connecting line. A terminal of the connecting line used to be connected to the main circuit board is easily loosened or even detached from the main circuit board due to shaking during transportation, which causes a signal of wireless transmission of the antenna device to be weakened or even interrupted.

### SUMMARY

The disclosure provides an antenna device that may maintain an uninterrupted transmission process of wireless transmission.

An antenna device in the disclosure includes a circuit board, a wireless module, an antenna module, and a fixing cover. The circuit board has a first connector. The wireless module is disposed on the circuit board and is electrically connected to the first connector through the circuit board. The antenna module includes an antenna, a transmission cable, and a second connector. The transmission cable is connected between the antenna and the second connector, and the second connector is connected to the first connector. The fixing cover is fixed to the circuit board, and the fixing cover is in contact with the second connector.

In an embodiment, the second connector is disposed between the first connector and the fixing cover.

In an embodiment, the first connector and the second connector are MHF antenna connectors.

In an embodiment, the wireless module is disposed in an area covered by the orthogonal projection of the fixing cover on the circuit board.

In an embodiment, the fixing cover has a top wall and a plurality of side walls surrounding the top wall. One of the side walls has a notch, and the second connector is disposed in the notch. An upper edge of the notch is in contact with the second connector.

In an embodiment, the antenna device further includes a thermal pad. The thermal pad is disposed between the top wall of the fixing cover and the wireless module.

In an embodiment, a portion of the second connector is disposed in the area covered by the orthogonal projection of the fixing cover on the circuit board.

In an embodiment, a material of the fixing cover is metal of copper-nickel-zinc alloy.

In an embodiment, the antenna device further includes a plurality of locking members locked into the circuit board passing through the fixing cover.

Based on the above, the fixing cover presses the second connector from above the second connector, so that the second connector may maintain proper connection with the first connector and prevent the second connector from detaching from the first connector. Therefore, the transmission process of wireless transmission may be kept uninterrupted.

### BRIEF DESCRIPTION OF THE DRAWINGS

FIG. 1 is a schematic exploded view of an antenna device according to an embodiment of the disclosure.

FIG. 2 is a schematic top view of the antenna device in FIG. 1 after assembly.

FIG. 3 is a schematic view taken along a section line A-A in FIG. 2.

### DETAILED DESCRIPTION OF DISCLOSED EMBODIMENTS

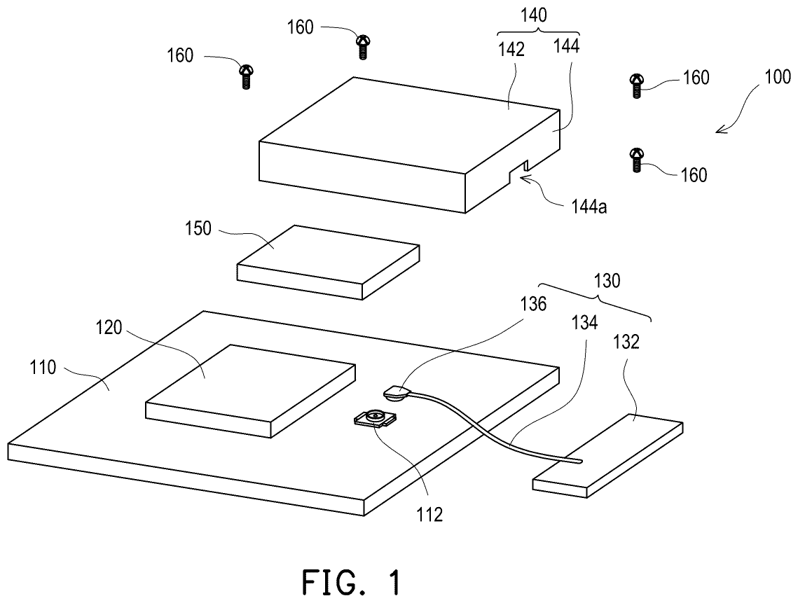

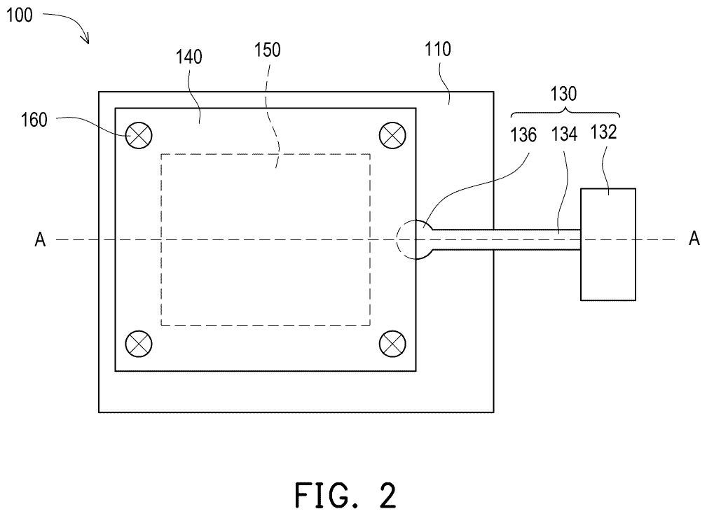

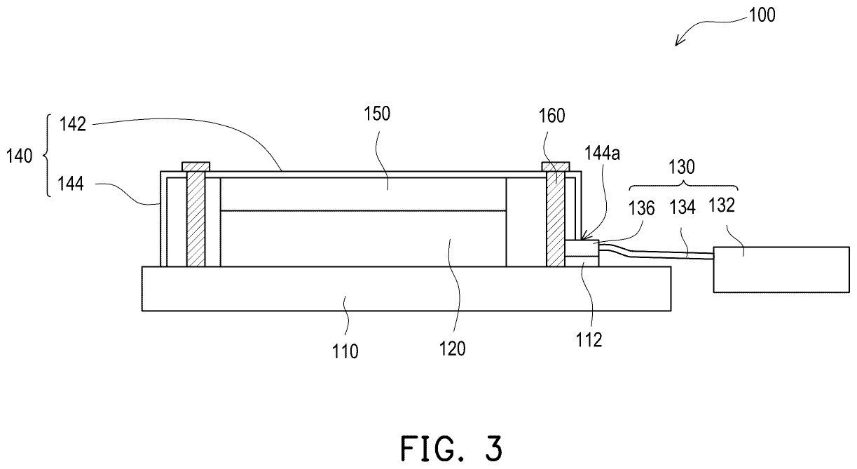

FIG. 1 is a schematic exploded view of an antenna device according to an embodiment of the disclosure. FIG. 2 is a schematic top view of the antenna device in FIG. 1 after assembly. FIG. 3 is a schematic view taken along a section line A-A in FIG. 2. Referring to FIGS. 1, 2, and 3 together, an antenna device 100 may be used in a charging pile. In this embodiment, the antenna device 100 includes a circuit board 110, a wireless module 120, an antenna module 130, and a fixing cover 140.

The circuit board 110 is provided with a first connector 112, and the first connector 112 may be a socket in a MHF antenna connector. The wireless module 120 is disposed on the circuit board 110, and the wireless module 120 is electrically connected to the first connector 112 through the circuit board 110. In some embodiments, the circuit board 110 has circuit lines, and the wireless module 120 is electrically connected to the first connector 112 through the circuit lines of the circuit board 110.

The antenna module 130 includes an antenna 132, a transmission cable 134, and a second connector 136. The transmission cable 134 is connected between the antenna 132 and the second connector 136. The second connector 136 may be a coaxial connector in the MHF antenna connector. The second connector 136 is used to be connected to the first connector 112 from above the first connector 112. The antenna module 130 is electrically connected to the wireless module 120 by plugging the second connector 136 into the first connector 112. The wireless module 120 transmits a transmission signal to the antenna 132 through the first connector 112, the second connector 136, and the transmission cable 134, and the antenna 132 transmits the transmission signal. In some embodiments, the antenna 132 is a planar printed antenna disposed on a substrate.

The fixing cover 140 is fixed to the circuit board 110 from above the second connector 136. The fixing cover 140 is in contact with the second connector 136 and presses the second connector 136.

The fixing cover 140 is in contact with and presses the second connector 136, so that the second connector 136 may be firmly plugged into the first connector 112, and the second connector 136 will not be loosened or detached from the first connector 112.

Continuing to refer to FIGS. 1, 2, and 3, in this embodiment, the wireless module 120 is located in an area covered by the orthogonal projection of the fixing cover 140 on the circuit board 110.

Specifically, the fixing cover 140 may be formed by metal of copper-nickel-zinc alloy as a hollow open box, which has a top wall 142 and multiple side walls 144 surrounding the top wall 142. The top wall 142 is located above the wireless module 120, and the side walls 144 surround the wireless module 120. In other words, the wireless module 120 is disposed in a space defined by the circuit board 110 and the fixing cover 140.

One of the side walls 144 of the fixing cover 140 has a notch 144a for accommodating the second connector 136. Therefore, when the fixing cover 140 is assembled to the circuit board 110, an upper edge of the notch 144a is in contact with the second connector 136 and presses the second connector 136. According to FIG. 2, a portion of the second connector 136 is disposed in the area covered by the orthogonal projection of the fixing cover 140 on the circuit board 110.

In light of the above, the configuration of the fixing cover 140 may prevent the second connector 136 from detaching from the first connector 112 and maintain the connection between the second connector 136 and the first connector 112, thus ensuring that a transmission process between the antenna module 130 and the wireless module 120 is not interrupted.

In addition, since the fixing cover 140 is formed by the metal of copper-nickel-zinc alloy, and since a copper-nickel-zinc alloy has a property of not being easily oxidized, components covered by the fixing cover 140 may be protected by the fixing cover 140 to reduce oxidation of the components, extend service life of the components, and maintain operating quality of the components.

Furthermore, the configuration of the fixing cover 140 may achieve an effect of suppressing electromagnetic wave noise and reducing external interference in antenna transmission efficiency.

The antenna device 100 further includes a thermal pad 150 disposed between the top wall 142 of the fixing cover 140 and the wireless module 120. The thermal pad 150 is in contact with at least one of the wireless module 120 and the top wall 142 of the fixing cover 140 to improve an overall heat dissipation effect of the antenna device 100, thereby improving operational reliability of wireless charging of the charging pile.

Specifically, the thermal pad 150 in this embodiment is in contact with the wireless module 120 and the top wall 142 of the fixing cover 140. Therefore, heat generated by an operation of the wireless module 120 is transferred to the fixing cover 140 through the thermal pad 150 in a manner of conduction and then dissipated. In this way, computing performance of the wireless module 120 may be improved. In another embodiment not shown, the thermal pad 150 may only be in contact with one of the top wall 142 of the fixed cover 140 and the wireless module 120. The element that is in contact with the thermal pad 150 may perform heat transfer in a manner of thermal conduction, while another element that is not in contact with the thermal pad 150 may perform the heat transfer in a manner of thermal radiation.

The fixing cover 140 may be fixed to the circuit board 110 through welding, buckling, clamping, etc. In order to increase stability of the fixing cover 140 being assembled on the circuit board 110, multiple locking members 160 may be further used to be locked into the circuit board 110 passing through the fixing cover 140 to improve assembly stability of the fixing cover 140 relative to the circuit board 110. Locking members 160 may be screws.

Based on the above, in the antenna device of the disclosure, the fixing cover is in contact with and presses the second connector from above the second connector, so that the second connector may maintain proper connection with the first connector and prevent the second connector from detaching from the first connector. Therefore, a transmission process of wireless transmission may be kept uninterrupted, providing stable wireless charging services and optimizing user experience.

In addition, since the fixing cover maintains the connection between the second connector and the first connector, the antenna device may adapt to various environmental conditions and provide the stable wireless charging services in various application scenarios.

What is claimed is:

1. An antenna device, comprising:
a circuit board having a first connector;
a wireless module disposed on the circuit board and electrically connected to the first connector through the circuit board;
an antenna module comprising an antenna, a transmission cable, and a second connector, wherein the transmission cable is connected between the antenna and the second connector, and the second connector is connected to the first connector; and
a fixing cover fixed to the circuit board, wherein the fixing cover is in contact with the second connector.

2. The antenna device according to claim 1, wherein the second connector is disposed between the first connector and the fixing cover.

3. The antenna device according to claim 1, wherein the first connector and the second connector are MHF antenna connectors.

4. The antenna device according to claim 1, wherein the wireless module is disposed in an area covered by the orthogonal projection of the fixing cover on the circuit board.

5. The antenna device according to claim 4, wherein the fixing cover has a top wall and a plurality of side walls surrounding the top wall, one of the side walls has a notch, the second connector is disposed in the notch, and an upper edge of the notch is in contact with the second connector.

6. The antenna device according to claim 5, further comprising a thermal pad disposed between the top wall of the fixing cover and the wireless module.

7. The antenna device according to claim 4, wherein a portion of the second connector is disposed in the area covered by the orthogonal projection of the fixing cover on the circuit board.

8. The antenna device according to claim 1, wherein a material of the fixing cover is metal of copper-nickel-zinc alloy.

9. The antenna device according to claim 1, further comprising a plurality of locking members locked into the circuit board passing through the fixing cover.
